(19) United States
(12) Patent Application Publication
(10) Pub. No.: US 2014/0335890 A1
(43) Pub. Date: Nov. 13, 2014

(54) LOCATING SYSTEM

(71) Applicants: Iluminado Hernandez, Bronx, NY (US); Bernadine Hernandez, Bronx, NY (US)

(72) Inventors: Iluminado Hernandez, Bronx, NY (US); Bernadine Hernandez, Bronx, NY (US)

(21) Appl. No.: 14/272,220

(22) Filed: May 7, 2014

Related U.S. Application Data
(60) Provisional application No. 61/820,738, filed on May 8, 2013.

(51) Int. Cl. H04W 4/02

(52) U.S. Cl. CPC H04W 4/02
USPC 455/456.1

(57) ABSTRACT

A locating system for locating an object is provided. The locating system comprises a transmitting device for transmitting a signal with the transmitting device communicable with a Bluetooth device. A receiving device receives the signal from the transmitting device with the receiving device releasably securable to the object. The locating system allows location of the object upon the receiving device being located a predetermined distance from the transmitting device.

The present application claims the benefit of priority of pending provisional patent application Ser. No. 61/820,738, filed on May 8, 2013, entitled “Locating system Device”.

### BACKGROUND OF THE INVENTION

1. Field of the Invention

This invention relates generally to a locating system and, more particularly, the invention relates to a locating system providing multifunctional alarm and monitoring system for helping parents quickly locate their child when he or she has wandered off or otherwise becomes separated from their caregiver.

2. Description of the Prior Art

As diligent as parents are in keeping a constant eye on their little ones, children are very curious and energetic by nature. Walking through a mall, strolling along the fairway of an amusement park, or enjoying a day out at a city park provide many attractive distractions that may inspire kids to wander off and investigate. In a split second, a child can be lost in these crowded and busy places. To help parents keep inquisitive children in sight at all times, there are several items on the market that can facilitate constant contact. Very popular in recent years, a child leash has become an alternative to constantly holding a child's hand to keep him from scampering off. Similar in style to a dog leash, one end of this harness is tied to the parent's arm while the other end is secured around the child's wrist. While these leashes help parents keep active children close by, they can result in chafing of the skin, particularly if a rambunctious child is tethered to it. Additionally, many people see the child leash as inhumane, and are discouraged from using one. In addition, parents have turned to two-way radios and even cellular telephones as means of staying in contact. While these costly items work well for close communication with kids old enough to be responsible for carrying them and using them, they could prove too challenging, and therefore impractical, as a security measure for younger children.

### SUMMARY

The present invention is a locating system for locating an object. The locating system comprises a transmitting device for transmitting a signal with the transmitting device communicable with a Bluetooth device. A receiving device receives the signal from the transmitting device with the receiving device releasably securable to the object. The locating system allows location of the object upon the receiving device being located a predetermined distance from the transmitting device.

In addition, the present invention includes a method for a method for locating an object. The method comprises providing a transmitting device, communicating the transmitting device with a Bluetooth device, providing a receiving device, releasably securing the receiving device to the object, transmitting a signal between the transmitting device and the receiving device for receiving the signal from the transmitting device, moving the receiving device a predetermined distance from the transmitting device, and locating the receiving device.

The present invention further includes a locating system for locating an object. The locating system comprises a transmitting device for transmitting a signal with the transmitting device communicable with a Bluetooth device. A clip mechanism is secured to the transmitting device. A first alarm mechanism is associated with the transmitting device. A receiving device receives the signal from the transmitting device with the receiving device releasably securable to the object. A second alarm mechanism is associated with the receiving device. The locating system allows location of the object upon the receiving device being located a predetermined distance from the transmitting device. The first alarm mechanism activates upon the receiving device being located a predetermined distance from the transmitting device and the second alarm mechanism activates upon the receiving device being located a predetermined distance from the transmitting device.

### BRIEF DESCRIPTION OF THE DRAWINGS

FIG. 1 is a front perspective view illustrating a receiving device of the locating system, constructed in accordance with the present invention;

FIG. 2 is a rear perspective view illustrating the receiving device of the locating system of FIG. 1, constructed in accordance with the present invention;

FIG. 3 is a front perspective view illustrating a transmitting device of the locating system, constructed in accordance with the present invention, with the transmitting device synchronizing to a cellular phone via a Bluetooth; and

FIG. 4 is a rear perspective view illustrating the transmitting device of the locating system of FIG. 3, constructed in accordance with the present invention, with an optional camera and an optional solar panel for powering the transmitting device.

### DETAILED DESCRIPTION OF THE PREFERRED EMBODIMENTS

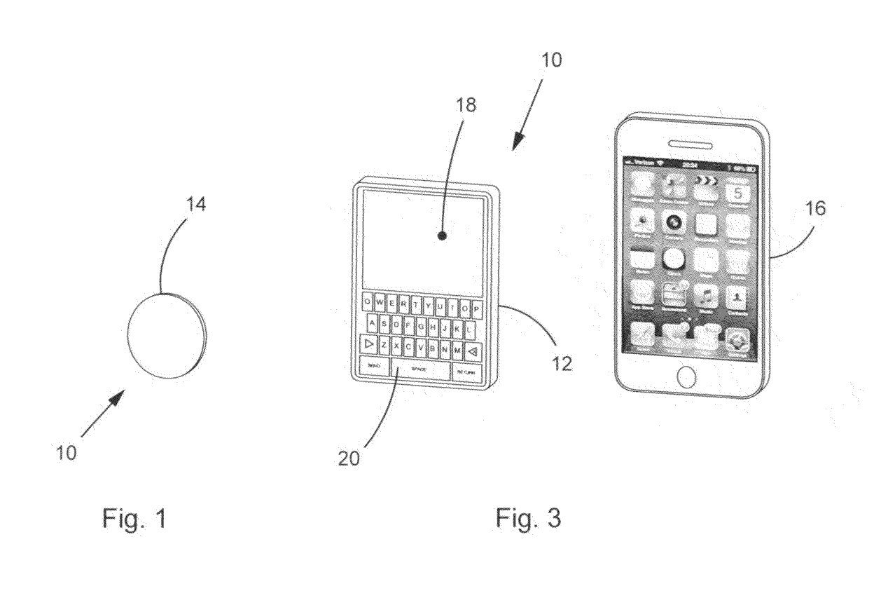

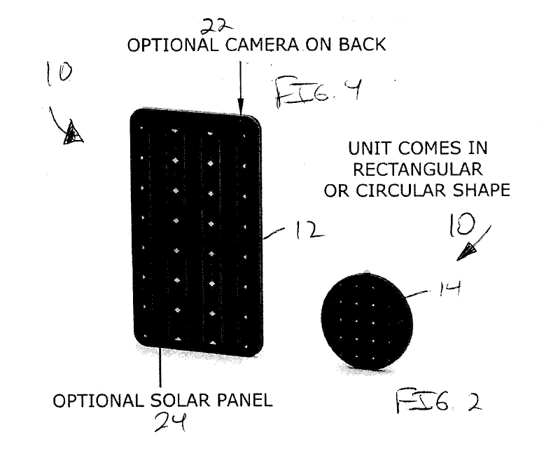

As illustrated in FIGS. 1-4, the present invention is a locating system, indicated generally at 10, providing multifunctional alarm and monitoring system for helping parents quickly locate their child when he or she has wandered off or otherwise becomes separated from their caregiver. The locating system 10 of the present invention is a two-part system consisting of a wearable transmitting device 12 for the parent and a companion receiving device 14 for the child.

Notably, the transmitting device 12 of the locating system 10 of the present invention can be programmed to work with existing Bluetooth devices 16, such as a cellular phone, Bluetooth earpiece or similar Bluetooth enabled items. Should the user not have a Bluetooth ready device, the transmitting device 12 is offered as an individual component to be carried or worn by the parent or caregiver.

Regardless of whether used alone, with a companion unit or existing Bluetooth enabled device 16, each component of the locating system 10 of the present invention is a compact, rectangular shaped device encased within a weather-resistant and ultra-thin housing measuring approximately 3.5 inches in length and 2 inches in width. As a consideration, a durable clip fastener, wrist band or comparable mechanism might be incorporated into the design of the transmitting device 12 and the receiving device 14 for use in easily securing the transmitting device 12 and/or the receiving device 14 to the person, a lanyard, key chain or other designated object. The top of the transmitting device 12 is preferably configured with a liquid crystal display (LCD) screen 18 and operational buttons 20 including an interactive touch screen control panel, touch screen keyboard and integrated speaker system. Internal components include a circuit board and Central Processing Unit (CPU); data storage disc; internal Bluetooth and Global Positioning System (GPS) software; and Wi-Fi system. As with traditional Wi-Fi and similar frequency transmitter and receiver systems, the transmitting device 12 features a frequency generator, amplifier, internal antenna, and the required electrical/ electronic components and circuitry, while the synched receiving device 14 consists of a tuned frequency, receiver circuit, and audible beeper. Importantly, these synced components can be programmed with a specific distance range as determined by the user. For instance, if using the locating system 10 to safeguard a child, the user might set the range at 3 feet for toddlers and perhaps 10 feet for older children. If using the locating system 10 to keep track of a pet or personal item, the user can set the locating system 10 anywhere from one to 50 feet, as deemed appropriate.

Notably, both the transmitting device 12 and the receiving device 14 of the locating system 10 of the present invention has an internal alarm mechanism that sounds should that distance of this preset range be breached. These alarms are also programmed to vibrate, as well as send a text message to the user providing information on utilizing the unit and locating the missing child. The components of the locating system 10 also each feature a USB connection port and cable for downloading or uploading information onto the unit from a home computer, as well as an internally contained rechargeable battery. Optional features include an integrated camera 22, as well a solar powered internal charger 24. As the locating system 10 has GPS technology in addition to the distance alarm feature, use of the locating system 10 enhances the parent's ability to know where the child is at all times, meticulously tracking the companion receiver as the child moves. As mentioned above, the locating device 10 is designed not just for lost children, but is also adaptable for use in locating any missing loved one, such as an elderly relative who may wander off; additionally, the system can be secured to dog or cat collars, thus providing a simple means of preventing pets from wandering off and easily locating them should they become lost. The transmitting and receiving capabilities also facilitate quick location of lost personal items.

The manner of use of the locating system 10 of the present invention will now be described. It will be understood by those skilled in the art that the manner of use of the locating system 10 described herein is merely one method of use and other methods of use of the locating system 10 are within the scope of the present invention.

Use of the locating system 10 of the present invention is very simple and straightforward. As mentioned, the locating system 10 can be programmed to work in conjunction with existing Bluetooth devices 16, or the user can utilize the two separate components offered for sale with the locating system 10. To employ the locating system 10, the parent first attaches the transmitting device 12 to his or her person and the receiving device 10 to the child to activate the locating system 10, adjusting both for security and comfort. If desired, the user sets the range alarm at a desired distance, so that the alarm sounds should the two parties become separated. With the locating system 10 powered on, both parent and child would be protected by the locating system 10. Should the child wander beyond the preset range, the alarm automatically sounds, enabling the parent to take quick action in retrieving their child. Should the child have wander out of sight, the parent would simply depress a dedicated button on the transmitting device 12. This action, in turn, wirelessly generates and transmits a signal. The companion receiving device 14, which is worn or secured to the child, is tuned to the specific frequency generated by the transmitter unit 12. Upon reception of the signal generated by the transmitting device 12, the circuitry in the receiving device 14 generates an ‘enable’ signal to a logic device (an ‘AND’ integrated circuit chip or comparable) which applies a voltage level to the alarm unit, causing the alarm unit to be activated. The alarm then emits a continuous audible sound, as well as vibrate, which is easily heard and discerned, making it quite simple to follow the sound and locate the youngster. A text message can also be sent to the user to provide further instructions for use and other pertinent data. If the parent cannot find the child, the GPS component of the locating system 10 is engaged, and the unit shows exactly where the child is located.

The locating system 10 of the present invention offers both parents and children numerous benefits and advantages. Foremost, the locating system 10 provides an effective means of ensuring a child's safety and a parent's peace of mind. While shopping, on vacation, or even at home, parents feel confident that their children will not wander off or get lost without their knowledge. Using the latest technology, the locating system 10 audibly keeps tabs on an out-of-sight child, emitting a resonant alarm the instant it is activated. In addition to alerting the parent, the locating system 10 also draws the attention of people surrounding the child. Offered as a completely portable device, the locating system 10. is easily worn on the person, tossed in a backpack or briefcase, or effortlessly carried. Not just for parents, the locating system 10 system proves beneficial to anyone responsible for child care, such as babysitters, nannies, and day care providers. Again, while child safety has been the primary focus, the supremely versatile the locating system 10 is easily employed for any situation where another person, pet, or object is missing, working in the same fashion as described above for children. Namely, caretakers of elderly patients who may suffer from dementia or Alzheimer's disease can rest assured that their loved ones would not be able to wander away too far, and get hurt, when protected by the locating system 10. In addition, the technology that comprises this system also proves beneficial to pet owners, as the locating system 10 can be expediently slipped onto a collar. Should a pet become lost, the simple activation of the locating system's 10 GPS system synchs with a transmitter located in the pet's collar, leading the owner to find the beloved pet. The locating system 10 also effectively assists users in quickly locating misplaced or left-behind objects that are essential to daily routine, as it can be easily affixed to personal and household items such as purses, keys, tools, remote control units, medications, and even cars, if one so wishes. Eliminating the need to fruitlessly dig through chair cushions, to crawl on the floor to search underneath furniture, or to root through every drawer in the house, the locating system 10 beeper pinpoints the location of an elusive item in a matter of seconds. As a result, precious time is not wasted on busy days when time is in short supply.

The locating system 10 of the present invention effectively and quickly alleviates the risk of a missing, lost, or abducted child, adult, or pet, along with personal valuables. Using today's technological advances, the locating system 10 fosters a sense of security for both parents and children, as well as caretakers and pet and property owners.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A locating system for locating an object, the locating system comprising:
a transmitting device for transmitting a signal, the transmitting device communicable with a Bluetooth device; and
a receiving device for receiving the signal from the transmitting device, the receiving device releasably securable to the object;
wherein the locating system allows location of the object upon the receiving device being located a predetermined distance from the transmitting device.

2. The locating system of claim 1 wherein the transmitting device has an alarm mechanism, the alarm mechanism activating upon the receiving device being located a predetermined distance from the transmitting device.

3. The locating system of claim 1 wherein the receiving device has an alarm mechanism, the alarm mechanism activating upon the receiving device being located a predetermined distance from the transmitting device.

4. The locating system of claim 1 wherein the transmitting device is releasably securable to the object.

5. The locating system of claim 1 wherein the Bluetooth device is a cellular phone or Bluetooth earpiece.

6. The locating system of claim 1 and further comprising:
a clip fastener mounted to the transmitting device.

7. The locating system of claim 1 wherein the receiving device has a securement device selected from a lanyard and a key chain.

8. The locating system of claim 1 wherein the transmitting device has a liquid crystal display (LCD) screen and operational buttons including an interactive touch screen control panel, touch screen keyboard, and integrated speaker system.

9. The locating system of claim 8 wherein the transmitting device has a circuit board and Central Processing Unit (CPU); data storage disc; internal Bluetooth and Global Positioning System (GPS) software; and Wi-Fi system.

10. The locating system of claim 9 wherein the transmitting device has a frequency generator, amplifier, internal antenna, and electrical/electronic components and circuitry, wherein the synched receiving device consists of a tuned frequency, receiver circuit, and audible beeper.

11. The locating system of claim 1 and further comprising:
a first USB connection port formed in the transmitting device; and
a second USB connection port formed in the receiving device.

12. The locating system of claim 1 wherein the transmitting device includes a camera.

13. The locating system of claim 1 wherein the transmitting device is powered by a rechargeable battery with a solar powered internal charger.

14. A method for locating an object, the method comprising:
providing a transmitting device;
communicating the transmitting device with a Bluetooth device;
providing a receiving device;
releasably securing the receiving device to the object;
transmitting a signal between the transmitting device and the receiving device for receiving the signal from the transmitting device;
moving the receiving device a predetermined distance from the transmitting device; and
locating the receiving device.

15. A locating system for locating an object, the locating system comprising:
a transmitting device for transmitting a signal, the transmitting device communicable with a Bluetooth device;
a clip mechanism secured to the transmitting device;
a first alarm mechanism associated with the transmitting device;
a receiving device for receiving the signal from the transmitting device, the receiving device releasably securable to the object; and
a second alarm mechanism associated with the receiving device;
wherein the locating system allows location of the object upon the receiving device being located a predetermined distance from the transmitting device;
wherein the first alarm mechanism activates upon the receiving device being located a predetermined distance from the transmitting device; and
wherein the second alarm mechanism activates upon the receiving device being located a predetermined distance from the transmitting device.

16. The locating system of claim 15 wherein the Bluetooth device is a cellular phone or Bluetooth earpiece.

17. The locating system of claim 14 wherein the receiving device has a securement device selected from a lanyard and a key chain.

18. The locating system of claim 14 wherein the transmitting device has a liquid crystal display (LCD) screen and operational buttons including an interactive touch screen control panel, touch screen keyboard, and integrated speaker system.

19. The locating system of claim 18 wherein the transmitting device has a circuit board and Central Processing Unit (CPU); data storage disc; internal Bluetooth and Global Positioning System (GPS) software; and Wi-Fi system.

20. The locating system of claim 19 wherein the transmitting device has a frequency generator, amplifier, internal antenna, and electrical/electronic components and circuitry, wherein the synched receiving device consists of a tuned frequency, receiver circuit, and audible beeper.
